(19) United States
(12) Patent Application Publication
(10) Pub. No.: US 2023/0318201 A1
(43) Pub. Date: Oct. 5, 2023

(54) FILTER ARRANGEMENT AND ANTENNA FEEDING NETWORK FOR A MULTI RADIATOR ANTENNA HAVING SUCH A FILTER ARRANGEMENT

(71) Applicant: Cellmax Technologies AB, Kista (SE)

(72) Inventors: Alf Ahlström, Spånga (SE); Anders Edquist, Täby (SE)

(21) Appl. No.: 17/712,422

(22) Filed: Apr. 4, 2022

(51) Int. Cl. H01Q 21/00; H01P 1/202

(52) U.S. Cl. CPC H01Q 21/0006; H01P 1/202

(57) ABSTRACT

Filter arrangement comprising an inner electric conductor comprising at least one inner conductor segment, an outer electric conductor at least partly surrounding the inner conductor, at least one dielectric element and at least one coil spring. The at least one dielectric element is arranged sandwiched between at least one inner conductor segment and the outer conductor to form a capacitance between the outer conductor and the inner conductor segment. The at least one coil spring is arranged inside said outer conductor to force the inner conductor segment and the at least one dielectric element against the outer conductor. The at least one coil spring is made from an electrically conducting material to form an inductance and is electrically connected with the inner conductor segment. An antenna feeding network and a multi-radiator antenna comprising such a filter arrangement is also provided.

### TECHNICAL FIELD

The invention relates to filter arrangements for RF applications. More specifically, the invention relates to filter arrangements for multi radiator base station antennas.

### BACKGROUND

Filter arrangements for RF applications are known in the art. Such filter arrangements include low pass filters used in base station antennas for mobile communication. Such an antenna may comprise a connector through which not only the RF signal, but also a DC voltage and a communication signal for ancillary devices such as a RET (Remote Electrical Tilt) motor is provided. A low pass filter is used to filter out or block the RF signal to provide the DC voltage and communication signal for the ancillary device. In such a case the communication may be modulated on a carrier as defined in, e.g., 3GPP specification TS 25.461.

U.S. Patent Publication US2003/0001697 discloses a known low pass filter having a circuit (FIG. 1A in US2003/0001697) consisting of a series of inductors alternating with shunt capacitors realized as a coaxial transmission line (FIG. 1B) that includes an outer conductor and an inner conductor structure separated from one another by a dielectric. The inner conductor structure includes short high-impedance conductor sections (inductances) and in-between these low-impedance disks (capacitances). In antenna applications as described above, a quite low cut-off frequency is required which means that both the inductors and capacitors need to be large. High inductance may be achieved by replacing the high-impedance sections in US2003/0001697 with coils. High capacitance however requires a very thin dielectric film, which means that mechanical tolerances must be very tight. This requirement causes production to be difficult and expensive.

Thus, there is a need for an improved filter arrangement.

### SUMMARY

An object of the invention is to solve or improve on at least some of the problems mentioned above in the background section.

These and other objects are achieved by the present invention by means of a filter arrangement according to the independent claim.

According to a first aspect of the invention there is provided a filter arrangement comprising an inner electric conductor comprising at least one inner conductor segment, an outer electric conductor at least partly surrounding the inner conductor, at least one dielectric element and at least one coil spring. The at least one dielectric element is arranged sandwiched between at least one inner conductor segment and the outer conductor to form a capacitance between the outer conductor and the inner conductor segment. The at least one coil spring is arranged inside said outer conductor to force the inner conductor segment and the at least one dielectric element against the outer conductor. The at least one coil spring is made from an electrically conducting material to form an inductance and is electrically connected with the inner conductor segment.

In other words, the inner electric conductor and the at least one dielectric element are surrounded at least partly by the outer conductor in the sense that the inner electric conductor and the at least one dielectric element are at least partly arranged inside the outer conductor. At least partly should be interpreted in the sense that one or more portions of the inner conductor or dielectric element may protrude outside the outer conductor. The at least one coil spring is also surrounded by the outer conductor. Put differently, the outer conductor forms a compartment in which the inner conductor, the dielectric element(s) and the coil spring(s) are arranged. It is understood that the inner conductor may be either wholly or partly formed by the inner conductor segments. For example, one or more of the coil springs may interconnect inner conductor segments and thus also form part of the inner conductor to form a signal path between an input and an output of the filter. It is furthermore understood that the at least one coil spring is arranged inside said outer conductor to force the inner conductor segment and the at least one dielectric element against an inner surface of the outer conductor. It is furthermore understood that the at least one dielectric element is sandwiched between at least one inner conductor segment and the outer conductor in the sense that it is arranged in abutment with an inner wall portion of the outer conductor and the inner conductor segment. It is furthermore understood that the inner conductor acts as a signal line and the outer conductor as a ground line. It is furthermore understood coil spring in this context refers to a compression spring which may be any type of coil spring for instance a helical coil spring or a coil spring having a non-circular cross section, for instance a substantially square cross section, i.e. a square coil spring. Furthermore, the cross section may be substantially constant along the axial direction of the coil spring, such as in a helical coil spring, or have a non-constant cross-section such as in a volute spring. Furthermore, the wire of the coil spring may have a circular or non-circular cross section.

The invention is based on the insight that a coil can function not only as an inductance both also as a spring, and further that its spring function can be used to force one or more inner conductor segments towards the outer conductor with dielectric element(s) sandwiched therebetween in close abutment with each other and without air gaps due to the spring force. Thereby, accurate capacitances of sufficiently high values can be achieved. Due to the spring action, the tolerances of the outer conductor do not need to be very tight. The filter arrangement is particularly suitable for radio frequency (RF) applications, and in particularly as a low pass filter is used to filter out/block the RF signal to provide a DC voltage and communication signal for an ancillary device. Such a low pass filter may also be referred to as “RF block”.

According to a second aspect of the invention, there is provided an antenna feeding network for a multi-radiator antenna, the antenna feeding network comprising at least two elongated outer conductors forming elongated compartments, said at least two elongated outer conductors being formed integrally and in parallel, wherein at least one of the outer conductors is provided with a central inner conductor arranged therein to form at least one substantially air-filled coaxial line. The antenna feeding network comprises a filter arrangement according to the first aspect of the invention or embodiments thereof, wherein the outer electric conductor of the filter arrangement is formed by one of the elongated outer conductors of the antenna feeding network.

According to a third aspect of the invention, there is provided a multi-radiator antenna comprising an antenna feeding network according to the second aspect of the invention or embodiments thereof and radiating elements being connected to the antenna feeding network.

In embodiments, the at least one coil spring is arranged in electrically abutting contact with the at least one inner conductor segment. Thus, a galvanic electric contact is achieved therebetween.

In embodiments, the at least one coil spring is arranged in electrical contact with the at least one inner conductor segment by means of a solder joint.

In alternative embodiments, the at least one coil spring is arranged in electrical contact with the at least one inner conductor segment via at least one electrically conducting connection element. The connection element may for instance be provided a holding portion such as a protrusion extending into the axial centre of the corresponding coil spring.

In embodiments comprising first and second inner conductor segments, a coil spring of the at least one coil spring is arranged to force the first and second inner conductor segments in opposite directions against respective opposite inner wall portions of the outer conductor with a respective dielectric element arranged sandwiched therebetween, wherein the coil spring is electrically connected with the first and second inner conductor segments. The first and second inner conductor segments are thus electrically interconnected by the coil spring and thus together form a C-L-C circuit. One of the first and second inner conductor segments may form, or be connected to an input connector, and the other of the first and second inner conductor segments may form or be connected to an output connector. The filter arrangement thus forms a low pass filter having a C-L-C circuit.

In the above-mentioned embodiment, the first and second inner conductor segments may each be provided with a plate-shaped portion, wherein the plate-shaped portions of the first and second inner conductor segments are arranged facing each other at a distance from each other to form a capacitance therebetween. The plate-shaped portions facing each other are advantageously arranged in parallel with each other to form a well-defined capacitance. The plate-shaped portions are disposed at an angle, preferably at right angle, relative the rest of the respective inner conductor segment. The plate-shaped portions are thus directed inwardly towards the inner wall portions against which the opposite inner conductor segment is forced. The plate-shaped portions may be arranged protruding substantially perpendicularly relative a lengthwise direction of the outer conductor. A dielectric element may be arranged between the plate-shaped portions. The capacitance formed by the plate-shaped portions of the first and second inner conductor segments is electrically in parallel with the inductance formed by the coil spring. By adapting the dimensions of the plate-shaped portions (and optionally the dimensions of the dielectric element therebetween) and the geometric properties (wire thickness, number of turns for example) to each other the capacitance and the inductance may form a resonant circuit providing a transmission zero in the transfer function. This may be advantageous to provide a steeper roll off characteristic of the low pass filter.

In embodiments, the inner electric conductor comprises two consecutively arranged inner conductor segments, each being provided with a plate-shaped portion, wherein the plate-shaped portions are arranged facing each other at a distance from each other to form a capacitance therebetween. In other words, two inner conductor segments are arranged after one another arranged forced (by means of respective coil springs) against the same inner wall portion of the outer conductor with a common, or respective, dielectric element(s) sandwiched therebetween. The plate-shaped portions facing each other are advantageously arranged in parallel with each other to form a well-defined capacitance. The plate-shaped portions are disposed at an angle, preferably at right angle, relative the rest of the respective inner conductor segment. The plate-shaped portions may be arranged protruding substantially perpendicularly relative a lengthwise direction of the outer conductor. A dielectric element may be arranged between the plate-shaped portions. The capacitance formed by the plate-shaped portions interconnect the consecutively arranged inner conductor segments, thus forming a serially arranged capacitance, which may form part of a high-pass or band-pass filter.

In embodiments, the outer conductor has a substantially rectangular or square cross-section in the sense that the cross section it is formed as a parallelogram whose angles are substantially right angles, for example within an interval of 85-95 degrees and/or in the sense that the corners of the rectangle or square are rounded. The at least one inner conductor segment may comprise at least one substantially plate-shaped portion, which each may be arranged in parallel with a plane inner wall portion of the outer conductor. Thereby, a filter arrangement which is easy to manufacture is achieved. The at least one coil spring may be arranged with a lengthwise direction (which may also be referred to as an axial direction) thereof substantially perpendicularly relative a lengthwise direction of the outer conductor. Thereby, a compact filter arrangement is achieved. In embodiments, at least two coil springs are arranged substantially in parallel in said outer conductor.

In embodiments comprising at least two parallel coil springs, a first coil spring and a second coil spring are wound in opposite directions. This may be advantageous since unwanted mutual coupling between the two inductances may be reduced. It is understood that wanted and unwanted mutual coupling between the formed capacitances and inductances can be tuned by altering capacitor and/or coil design.

The features of the embodiments described above are combinable in any practically realizable way to form embodiments having combinations of these features. Further, all features and advantages of embodiments described above with reference to the first aspect of the invention may be applied in corresponding embodiments of the second and third aspects of the invention.

### BRIEF DESCRIPTION OF THE DRAWINGS

Above discussed and other aspects of the present invention are described in more detail using the appended drawings, which show preferred embodiments of the invention, wherein:

FIG. 1a schematically illustrates a first embodiment of a filter arrangement in a cross-sectional view,

FIG. 1b shows a side view of the embodiment in FIG. 1a,

FIG. 1c shows an electric schematic illustrating the basic topology implemented by the filter arrangement in FIG. 1a-b,

FIG. 2a schematically illustrates a second embodiment of a filter arrangement,

FIG. 2b shows an electric schematic illustrating the basic topology implemented by the filter arrangement in FIG. 2a,

FIG. 3a schematically illustrates a third embodiment of a filter arrangement,

FIG. 3b shows an electric schematic illustrating the basic topology implemented by the filter arrangement in FIG. 3a,

FIG. 4a schematically illustrates a fourth embodiment of the filter arrangement,

FIG. 4b shows an electric schematic illustrating the basic topology implemented by the filter arrangement in FIG. 4a, and

FIG. 5 schematically illustrates an embodiment of a multi-radiator antenna, which comprises an embodiment of the antenna feeding network having a filter arrangement.

### DETAILED DESCRIPTION

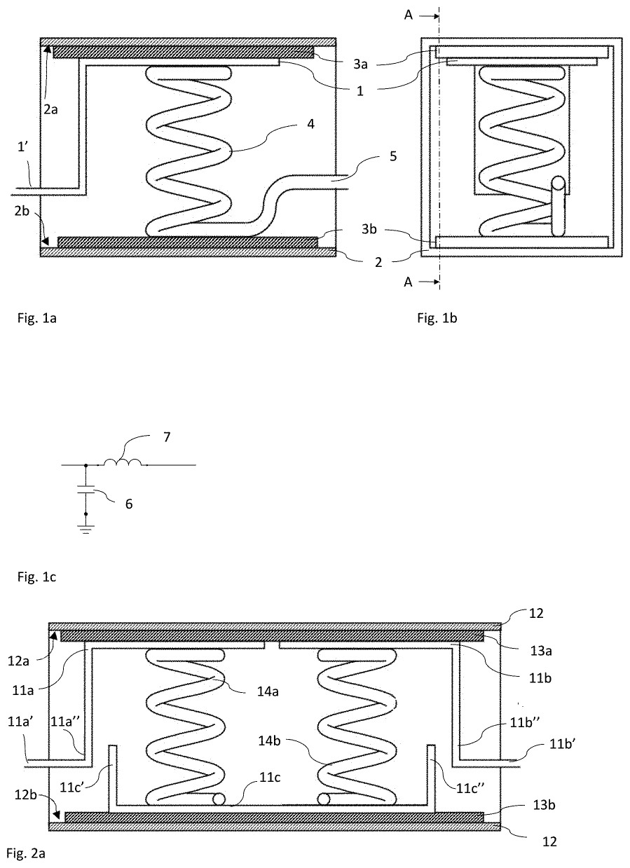

FIGS. 1a and 1b schematically illustrate a first embodiment of the filter arrangement according to the first aspect of the invention. FIG. 1b shows a side view of the filter arrangement and FIG. 1a is a cross section view taken along the line A-A. An inner electric conductor is formed by an inner conductor segment 1. An outer electric conductor 2 having a rectangular cross section surrounds the inner conductor 1 except for connecting portion 1′ which extends out beyond the outer conductor and is configured to provide a signal line input connection to the filter arrangement. In other embodiments, the connecting portion 1′ and the wire 5 do not extend outside the outer conductor. This is particularly the case when the filter arrangement is formed as part of an antenna feeding arrangement (see FIG. 5). A first dielectric element 3a is arranged sandwiched between the inner conductor segment 1 and an inner wall portion 2a of the outer conductor 2 to form a capacitance between the outer conductor 2 and the first inner conductor segment 1. A helical coil spring 4 is arranged inside said outer conductor to force the first inner conductor segment 1 and the first dielectric element 3a against the outer conductor. A second dielectric element 3b is arranged at the opposite (lower) end of the helical coil spring to electrically insulate the spring from the outer conductor. The helical coil spring is made from an electrically conducting material to form an inductance and is arranged in electrically abutting galvanic contact with the inner conductor segment 1. The inner wall portions 2a, 2b of the outer conductor 2, the dielectric elements 3a, 3b and the abutting portion of the inner conductor segment 1 are all plane. An output connection is realized by means of wire 5 forming an extension of the spring 4. In this embodiment, the inner conductor, which may also be referred to the signal line, is formed by the inner conductor segment 1 in series with the spring 4 and wire 5. The output connection may in other embodiments be realized in a different manner, for instance by introducing an additional inner conductor segment identical to the inner conductor segment 1. In such an embodiment, the additional inner conductor will also function as a capacitance to ground.

FIG. 1c shows an electric schematic illustrating the basic topology implemented by the filter arrangement in FIG. 1a. Capacitor 6 corresponds to the capacitance formed by inner conductor segment 1, dielectric element 3a and the outer conductor 2. Inductor 7 corresponds to the inductance formed by helical coil spring 4.

FIG. 2a schematically illustrates a second embodiment of the filter arrangement according to the first aspect of the invention. FIG. 2a is a cross section view in a corresponding manner as in FIG. 1a. An inner electric conductor is formed by inner conductor segments 11a, 11b and 11c. An outer electric conductor 12 having a rectangular cross section surrounds the inner conductor segments except for connecting portions 11a′, 11b′ which extend out beyond the outer conductor and are configured to provide input/output connections to the filter arrangement. A first dielectric element 13a is arranged sandwiched between the first inner conductor segment 11a and an upper inner wall portion 12a of the outer conductor 12 to form a capacitance between the outer conductor 12 and the first inner conductor segment 11a. The first dielectric element 13a is also arranged sandwiched between the second inner conductor segment 11b and the upper inner wall portion 12a of the outer conductor 12 to form a capacitance between the outer conductor 12 and the second inner conductor segment 11b. A second dielectric element 13b is arranged sandwiched between the third inner conductor segment 11c and a lower inner wall portion 12b of the outer conductor 12 to form a capacitance between the outer conductor 12 and the third inner conductor segment 11c. Helical coil springs 14a, 14b are arranged in parallel inside the outer conductor perpendicular to a lengthwise direction of the outer conductor 12, i.e., perpendicular to the inner wall portions 12a-b. In order to minimize feedback between the inductances formed by the helical coil springs, they are arranged at a distance from each other in the lengthwise direction and are also, as can be seen in FIG. 2a, wound in opposite directions. Spring 14a forces the first inner conductor segment 11a and the first dielectric element 13a upwards against the upper inner wall portion of the outer conductor. Spring 14b forces the second inner conductor segment 11b and the first dielectric element 13a upwards against the upper inner wall portion of the outer conductor. Both springs 14a, 14b force the third inner conductor segment 11c and the second dielectric element 13b downwards against the lower inner wall portion of the outer conductor. The inner wall portions 12a-b of the outer conductor, the dielectric elements 13a-b and the portion of the inner conductor segments 11a-c in abutment therewith are all plane. The helical coil springs 14a-b are made from an electrically conducting material to form inductances and are arranged in electrically abutting galvanic contact with the respective inner conductor segments.

The first and second inner conductor segments 11a, 11b are each provided with a plate-shaped downwardly perpendicularly protruding portion 11a″, 11b″. The third inner conductor segment 11c is provided with plate-shaped upwardly perpendicularly protruding portion 11c′, 11c′ at the opposite lengthwise ends thereof. Plate-shaped portion 11a″ and plate-shaped portion 11c′ are arranged at a distance from each other to form a capacitance therebetween which is electrically in parallel with the inductance formed by the helical coil spring 14a. Plate-shaped portion 11b″ and plate-shaped portion 11c″ are arranged at a distance from each other to form a capacitance therebetween which is electrically in parallel with the inductance formed by the helical coil spring 14b. In other embodiments, dielectric element(s) may be arranged between the plate-shaped portions.

FIG. 2b shows an electric schematic illustrating the basic topology implemented by the filter arrangement in FIG. 2a. Capacitor 16a corresponds to the capacitance formed by the first inner conductor segment 11a, dielectric element 13a and the outer conductor 12. Inductor 17a corresponds to the inductance formed by helical coil spring 14a and capacitor 17b corresponds to the capacitance formed by plate-shaped portions 11a″ and 11c′. Inductor 17a and capacitor 17b forms a resonant circuit. Capacitor 16b corresponds to the capacitance formed by the third inner conductor segment 11c, dielectric element 13b and the outer conductor 12. Inductor 18a corresponds to the inductance formed by helical coil spring 14b and capacitor 18b corresponds to the capacitance formed by plate-shaped portions 11b″ and 11c″. Inductor 18a and capacitor 18b forms a resonant circuit. Capacitor 16c corresponds to the capacitance formed by the second inner conductor segment 11b, dielectric element 13a and the outer conductor 12. As can be seen, the resulting topology is a low-pass filter. Transmission zeros are present due to the resonant circuits 17a/17b and 18a/18b.

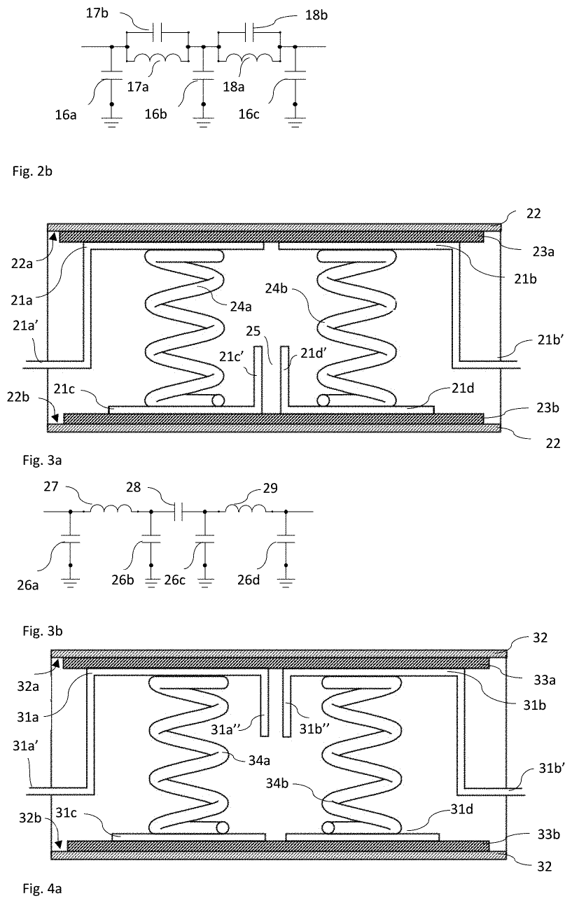

FIG. 3a schematically illustrates a third embodiment of the filter arrangement according to the first aspect of the invention. This embodiment corresponds to the embodiment in FIG. 2a in the sense that it comprises an outer conductor 22, first/second dielectric elements 23a/23b, helical coil springs 24a/24b, and first and second inner conductor segments 21a/21b with connecting portions 21a′/21b′ being identical to the corresponding features in FIG. 2a.

The embodiment in FIG. 3a however differs in that it comprises a third inner conductor segment 21c forced downwardly towards the dielectric element 23b by the spring 24a, and a fourth inner conductor segment 21d forced downwardly towards the dielectric element 23b by the spring 24b. The third and fourth inner conductor segments 21c, 21d are each provided with a plate-shaped upwardly perpendicularly protruding portion 21c′, 21d′. Plate-shaped portion 21c′ and plate-shaped portion 21d′ are arranged at a distance from each other with a space 25 therebetween to form a capacitance therebetween. Optionally, a dielectric element therebetween may be arranged at 25.

FIG. 3b shows an electric schematic illustrating the basic topology implemented by the filter arrangement in FIG. 3a. Capacitor 26a corresponds to the capacitance formed by the first inner conductor segment 21a, dielectric element 23a and the outer conductor 22. Inductor 27 corresponds to the inductance formed by helical coil spring 24a. Capacitor 26b corresponds to the capacitance formed by the third inner conductor segment 21c, dielectric element 23b and the outer conductor 22. Capacitor 28 corresponds to the capacitance formed between plate-shaped portions 21c′ and 21d′. Inductor 29 corresponds to the inductance formed by helical coil spring 24b. Capacitor 26c corresponds to the capacitance formed by the fourth inner conductor segment 21d, dielectric element 23b and the outer conductor 22. Capacitor 26d corresponds to the capacitance formed by the second inner conductor segment 21b, dielectric element 23a and the outer conductor 22. As can be seen, the resulting topology is a band-pass filter.

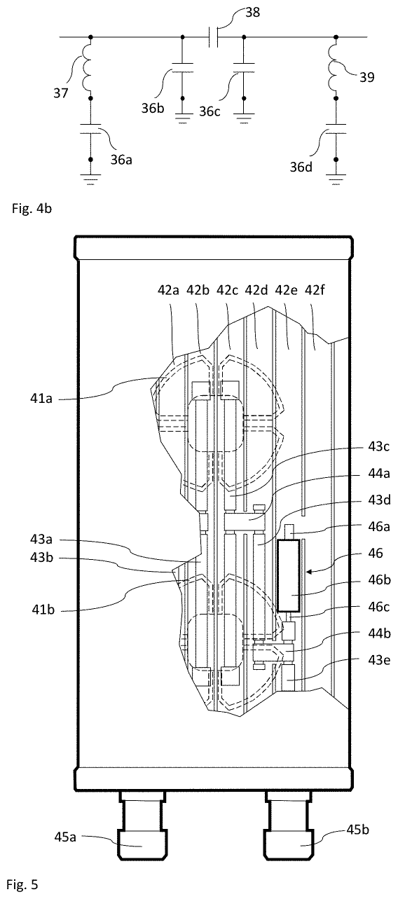

FIG. 4a schematically illustrates a fourth embodiment of the filter arrangement according to the first aspect of the invention. FIG. 4a is a cross section view in a corresponding manner as in FIG. 1a. An inner electric conductor is formed by inner conductor segments 31a, 31b, 31c and 31d. An outer electric conductor 32 having a rectangular cross section surrounds the inner conductor segments except for connecting portions 31a′, 31b′ which extend out beyond the outer conductor and are configured to provide input/output connections to the filter arrangement. A first dielectric element 33a is arranged sandwiched between the first inner conductor segment 31a and an upper inner wall portion 32a of the outer conductor 32 to form a capacitance between the outer conductor 32 and the first inner conductor segment 31a. The first dielectric element 33a is also arranged sandwiched between the second inner conductor segment 31b and the upper inner wall portion 32a of the outer conductor 32 to form a capacitance between the outer conductor 32 and the second inner conductor segment 31b. A second dielectric element 33b is arranged sandwiched between the third and fourth inner conductor segment 31c and 31d and a lower inner wall portion 32b of the outer conductor 32 to form capacitances between the outer conductor 32 and the third/fourth inner conductor segment 31c, 31d. Helical coil springs 34a, 34b are arranged in parallel inside the outer conductor perpendicular to a lengthwise direction of the outer conductor 32, i.e. perpendicular to the inner wall portions 32a-b. Spring 34a forces the first inner conductor segment 31a and the first dielectric element 33a upwards against the upper inner wall portion of the outer conductor. Spring 34b forces the second inner conductor segment 31b and the first dielectric element 33a upwards against the upper inner wall portion of the outer conductor.

The first and second inner conductor segments 31a, 31b are each provided with a plate-shaped downwardly perpendicularly protruding portion 31a″, 31b″. Plate-shaped portion 31a″ and plate-shaped portion 31b″ are arranged at a distance from each other (optionally with a dielectric element therebetween) to form a capacitance therebetween. The third inner conductor segment 31c is forced downwardly towards the dielectric element 33b by the spring 34a, and the fourth inner conductor segment 31d forced downwardly towards the dielectric element 33b by the spring 34b. The helical coil springs 14a-b are made from an electrically conducting material to form inductances and are arranged in electrically abutting galvanic contact with the respective inner conductor segments.

FIG. 4b shows an electric schematic illustrating the basic topology implemented by the filter arrangement in FIG. 4a. Capacitor 36a corresponds to the capacitance formed by the third inner conductor segment 31c, dielectric element 33b and the outer conductor 32. Inductor 37 corresponds to the inductance formed by helical coil spring 34a. Capacitor 36b corresponds to the capacitance formed by the first inner conductor segment 31a, dielectric element 33a and the outer conductor 32. Capacitor 38 corresponds to the capacitance formed between plate-shaped portions 31a″ and 31b″. Capacitor 36c corresponds to the capacitance formed by the second inner conductor segment 31b, dielectric element 33a and the outer conductor 32.

Capacitor 36d corresponds to the capacitance formed by the fourth inner conductor segment 31d, dielectric element 33b and the outer conductor 32. Inductor 39 corresponds to the inductance formed by helical coil spring 34b. As can be seen, the resulting topology is a high-pass filter. Transmission zeros are present due to the resonant circuits 36a/37 and 36d/39.

FIG. 5 schematically illustrates an antenna feeding network according to a second aspect of the invention and an embodiment of the multi-radiator antenna according to a third aspect of the invention, which comprises an embodiment of the antenna feeding network according to the second aspect of the invention. The multi-radiator antenna comprises an antenna feeding network and radiating elements 41a, 41b being connected to the antenna feeding network. The multi-radiator antenna is seen from behind the antenna feeding network/reflector in a partial cut-away view. The antenna feeding network is of the same type as disclosed in US2019051960A1 (which is hereby incorporated by reference), except for the addition of a filter arrangement according to the first aspect of the present invention. In this embodiment, the antenna feeding network comprises eight outer conductors (six are visible in FIG. 5, ref. 42a-f), each forming an elongated compartment. The elongated outer conductors are formed integrally and in parallel in the form of an extruded aluminium profile which also functions as a reflector. As can be seen in FIG. 5, each of the outer conductors 42a-e is provided with a respective central inner conductor 43a-e arranged therein to form substantially air-filled coaxial lines. Inner conductor 43e is connected at its first end to coaxial connector 45b, and at its second end to a filter arrangement 46. In the vicinity of the second end, a connector device 44b connects the inner conductor 43e to inner conductor 43d which in turn is connected to a middle portion of inner conductor 43c to split/combine the signal to/from both radiating elements 41a, 41b.

The filter arrangement 46 is a low pass filter of the same type shown in FIG. 2a. The inner conductor 43e connects to connecting portion 46c (corresponding to 11a′ in FIG. 2a) of the filter arrangement. The outer electric conductor of the filter arrangement is formed by the outer conductor 42e of the antenna feeding network. The dielectric element 46b corresponds to ref. 13a in FIG. 2a. The connecting portions 46a corresponds to ref. 11b′ in FIG. 2a. In other embodiments, the filter arrangement 46 may be a band pass filter for instance as shown in FIG. 3a. The low/band pass filter is configured to filter out/block the RF signal to provide DC voltage and communication signal for a RET (Remove Electrical Tilt) motor (not shown) which is connectable to connecting portion 46a.

It is understood that inner conductors 43a, 43b and the inner conductor in the not visible outer conductor to the left of outer conductor 42a are interconnected with corresponding connector devices as outer conductors 42c-e and are connected in a corresponding manner to coaxial connector 45a, but without a filter arrangement as in outer conductor 42e.

The description above and the appended drawings are to be considered as non-limiting examples of the invention. The person skilled in the art realizes that several changes and modifications may be made within the scope of the invention. In particular, it is pointed out that higher or lower order filter arrangements than the above illustrated embodiments may be achieved by adding or removing inner conductor segments and/or helical coil springs and/or by combining features of the illustrated embodiments. Furthermore, the number of coaxial lines may be varied, and the number of radiators/dipoles may be varied.

1. A filter arrangement comprising:
an inner electric conductor comprising at least one inner conductor segment;
an outer electric conductor at least partly surrounding the inner conductor;
at least one dielectric element arranged sandwiched between at least one inner conductor segment and the outer conductor to form a capacitance between the outer conductor and the inner conductor segment;
at least one coil spring arranged inside said outer conductor to force the inner conductor segment and the at least one dielectric element against the outer conductor,
wherein said at least one coil spring is made from an electrically conducting material to form an inductance, and wherein said coil spring is electrically connected with said inner conductor segment.

2. The filter arrangement according to claim 1, wherein said at least one coil spring is arranged in electrically abutting contact with the at least one inner conductor segment.

3. The filter arrangement according to claim 1, comprising first and second inner conductor segments, wherein a coil spring of the at least one coil spring is arranged to force the first and second inner conductor segments in opposite directions against respective inner wall portions of the outer conductor with a respective dielectric element arranged sandwiched therebetween, wherein said coil spring is electrically connected with the first and second inner conductor segments.

4. The filter arrangement according to claim 3, wherein each of the first and second inner conductor segments is provided with a plate-shaped portion, wherein the plate-shaped portions of the first and second inner conductor segments are arranged facing each other at a distance from each other to form a capacitance therebetween.

5. The filter arrangement according to claim 1, wherein the inner electric conductor comprises two consecutively arranged inner conductor segments, each being provided with a plate-shaped portion, wherein the plate-shaped portions are arranged facing each other at a distance from each other to form a capacitance therebetween.

6. The filter arrangement according to claim 4, comprising a dielectric element arranged between said plate-shaped portions.

7. The filter arrangement according to claim 4, wherein said plate-shaped portions are formed substantially perpendicularly relative a lengthwise direction of the outer conductor.

8. The filter arrangement according to claim 1, wherein said outer conductor has a substantially rectangular cross-section, and wherein said at least one inner conductor segment comprise at least one substantially plane portion.

9. The filter arrangement according to claim 1, wherein said at least one coil spring is arranged with a lengthwise direction thereof substantially perpendicularly relative a lengthwise direction of the outer conductor.

10. The filter arrangement according to claim 1, comprising at least two coil springs arranged substantially in parallel in said outer conductor.

11. The filter arrangement according to claim 1, comprising first and second coil springs arranged in parallel inside the outer conductor,
wherein said inner conductor comprises first, second and third inner conductor segments, the first and second inner conductor segments being consecutively arranged,
wherein said first coil spring is arranged to force the first inner conductor segment against an upper portion of the outer conductor with a first dielectric element sandwiched therebetween,
wherein said second coil spring is arranged to force the second inner conductor segment against an upper portion of the outer conductor with a second dielectric element sandwiched therebetween,
wherein the first and second coil springs are arranged to force the third inner conductor segment against a lower portion of the outer conductor with a third dielectric element sandwiched therebetween,
wherein the first coil spring is electrically connected with the first and third inner conductor segments, and the second coil spring is electrically connected with the second and third inner conductor segments.

12. The filter arrangement according to claim 1, comprising first and second coil springs arranged in parallel inside the outer conductor, wherein the first and second coil springs are wound in opposite directions.

13. An antenna feeding network for a multi-radiator antenna, the antenna feeding network comprising at least two elongated outer conductors forming elongated compartments, said at least two elongated outer conductors being formed integrally and in parallel, wherein at least one of the outer conductors is provided with a central inner conductor arranged therein to form at least one substantially air-filled coaxial line, wherein the antenna feeding network comprises a filter arrangement comprising:
an inner electric conductor comprising at least one inner conductor segment;
an outer electric conductor at least partly surrounding the inner conductor;
at least one dielectric element arranged sandwiched between at least one inner conductor segment and the outer conductor to form a capacitance between the outer conductor and the inner conductor segment;
at least one coil spring arranged inside said outer conductor to force the inner conductor segment and the at least one dielectric element against the outer conductor,
wherein said at least one coil spring is made from an electrically conducting material to form an inductance, and wherein said coil spring is electrically connected with said inner conductor segment,
wherein the outer electric conductor of the filter arrangement is formed by one of the elongated outer conductors of the antenna feeding network.

14. The antenna feeding network according to claim 13, wherein the inner conductor of the filter arrangement is connected to at least one central inner conductor of the at least one coaxial line.

15. The antenna feeding network according to claim 13, comprising first and second inner conductor segments, wherein a coil spring of the at least one coil spring is arranged to force the first and second inner conductor segments in opposite directions against respective inner wall portions of the outer conductor with a respective dielectric element arranged sandwiched therebetween, wherein said coil spring is electrically connected with the first and second inner conductor segments.

16. The antenna feeding network according to claim 15, wherein each of the first and second inner conductor segments is provided with a plate-shaped portion, wherein the plate-shaped portions of the first and second inner conductor segments are arranged facing each other at a distance from each other to form a capacitance therebetween.

17. The antenna feeding network according to claim 13, wherein the inner electric conductor comprises two consecutively arranged inner conductor segments, each being provided with a plate-shaped portion, wherein the plate-shaped portions are arranged facing each other at a distance from each other to form a capacitance therebetween.

18. A multi-radiator antenna comprising an antenna feeding network and radiating elements being connected to the antenna feeding network, said antenna feeding network comprising at least two elongated outer conductors forming elongated compartments, said at least two elongated outer conductors being formed integrally and in parallel, wherein at least one of the outer conductors is provided with a central inner conductor arranged therein to form at least one substantially air-filled coaxial line, wherein the antenna feeding network comprises a filter arrangement comprising:
an inner electric conductor comprising at least one inner conductor segment;
an outer electric conductor at least partly surrounding the inner conductor;
at least one dielectric element arranged sandwiched between at least one inner conductor segment and the outer conductor to form a capacitance between the outer conductor and the inner conductor segment;
at least one coil spring arranged inside said outer conductor to force the inner conductor segment and the at least one dielectric element against the outer conductor,
wherein said at least one coil spring is made from an electrically conducting material to form an inductance, and wherein said coil spring is electrically connected with said inner conductor segment,
wherein the outer electric conductor of the filter arrangement is formed by one of the elongated outer conductors of the antenna feeding network.

19. The multi-radiator antenna according to claim 18, comprising first and second inner conductor segments, wherein a coil spring of the at least one coil spring is arranged to force the first and second inner conductor segments in opposite directions against respective inner wall portions of the outer conductor with a respective dielectric element arranged sandwiched therebetween, wherein said coil spring is electrically connected with the first and second inner conductor segments.

20. The multi-radiator antenna according to claim 19, wherein each of the first and second inner conductor segments is provided with a plate-shaped portion, wherein the plate-shaped portions of the first and second inner conductor segments are arranged facing each other at a distance from each other to form a capacitance therebetween.

21. The multi-radiator antenna according to claim 18, wherein the inner electric conductor comprises two consecutively arranged inner conductor segments, each being provided with a plate-shaped portion, wherein the plate-shaped portions are arranged facing each other at a distance from each other to form a capacitance therebetween.
